(19) United States
(12) Patent Application Publication
(10) Pub. No.: US 2015/0109103 A1
(43) Pub. Date: Apr. 23, 2015

(54) VEHICULAR PORTABLE DEVICE

(71) Applicant: DENSO CORPORATION, Kariya-city, Aichi-pref. (JP)

(72) Inventors: Tokio Shimura, Anjo-city (JP); Mitsuru Nakagawa, Chiryu-city (JP)

(73) Assignee: DENSO CORPORATION, Kariya-city, Aichi-pref. (JP)

(21) Appl. No.: 14/390,314

(22) PCT Filed: Mar. 20, 2013
(86) PCT No.: PCT/JP2013/001895

§ 371 Date: Oct. 2, 2014

(30) Foreign Application Priority Data
Apr. 3, 2012 (JP) 2012-085000

(51) Int. Cl. G07C 9/00

(52) U.S. Cl. CPC G07C 9/00309; G07C 2009/00357; G07C 2009/00769
USPC 340/5.61

(57) ABSTRACT

A portable device for a vehicle includes a short range communication antenna, a near field communication antenna, and a housing case. The short range communication antenna is utilized in a short range wireless communication with a communication device equipped to a vehicle. The near field communication antenna is utilized in a near field wireless communication. The short range communication antenna is disposed in the housing case. The near field communication antenna is disposed on the housing case by decorative printing. A communicable range of the short range wireless communication is longer than a communicable range of the near field wireless communication.

### CROSS REFERENCE TO RELATED APPLICATION

This application is based on Japanese Patent Application No. 2012-085000 filed on Apr. 3, 2012, the disclosure of which is incorporated herein by reference.

### TECHNICAL FIELD

The present disclosure relates to a portable device for a vehicle, particularly relates to a vehicular portable device that is able to perform a near field communication.

### BACKGROUND ART

A vehicular portable device, which performs a remote control of a vehicular device, is known. The vehicular portable device remotely controls the vehicular device, such as locking or unlocking of a vehicle door by performing a short range wireless communication with a vehicular wireless device equipped to the vehicle.

A vehicular portable device, which is also capable of performing a near field communication (NFC) in addition to the short range wireless communication, is known. In Japan, the “short range wireless communication” also refers to the “near field communication” that is defined under ISO/IEC 18092. In the present disclosure, the “short range wireless communication” refers to a wireless communication having a communicable range longer than a communicable range of the “near field communication” defined under ISO/IEC 18092.

Among the short range wireless communication and the near field communication having different communicable ranges with one another, a mobile phone is known as one example of a communication device that is able to perform the near field communication. For example, in a mobile phone disclosed in patent literature 1, an antenna for radio-frequency identification (RFID) is adhered to an inner surface of a battery cover 8. The antenna for RFID corresponds to an NFC antenna.

In order to perform both the short range wireless communication and the near field communication, two antennas respectively corresponding to the short range wireless communication and the near field communication are necessary. However, a vehicular portable device has a compact size, and where to dispose the two antennas becomes a problem.

For example, in the above-described configuration, the two antennas for the two types of communications may be disposed on a substrate. However, on the substrate, a space for disposing the antennas is limited since various electronic components and a battery are disposed on the substrate. Further, patent literature 1 discloses that the antenna is adhered to the inner surface of the battery cover 8. With this configuration, a large size antenna can be provided to the vehicular portable device by adhering the antenna to the inner surface of the cover, compared with disposing the antenna on the substrate. However, the cover usually has a frame for assembling the cover with a case, and the battery cover 8 shown in patent literature 1 also has the frame. When adhering the antenna to the inner surface of the cover, the antenna is required to be adhered within the frame. Thus, only an antenna having a size smaller than an internal boundary of the frame can be adhered to the inner surface of the cover. Further, in the battery cover 8 disclosed in patent literature 1, multiple beams are formed on the inner surface of the battery cover 8 to secure a strength of the battery cover 8. Usually, various protrusions, such as beams are formed on the inner surface of the cover, not limited to patent literature 1. When adhering the antenna to the inner surface of the cover, a space to dispose the antenna is limited to an inside portion of the internal boundary of the frame of the cover, and the space is further limited by the multiple protrusions within the internal boundary of the frame of the cover. Thus, even though the antenna is adhered to the inner surface of the cover, a size of the antenna is required to be reduced caused

### PRIOR ART LITERATURES

### Patent Literature

Patent Literature 1: JP 4698528 B2

### SUMMARY OF INVENTION

In view of the foregoing difficulties, it is an object of the present disclosure to provide a portable device for a vehicle that has a near field communication antenna having an increased size.

According to an aspect of the present disclosure, a portable device for a vehicle includes a short range communication antenna, a near field communication antenna, and a housing case. The short range communication antenna is utilized in a short range wireless communication with a communication device equipped to a vehicle. The near field communication antenna is utilized in a near field wireless communication. The short range communication antenna is disposed in the housing case. The near field communication antenna is disposed on the housing case by decorative printing.

In the above portable device, the near field communication antenna is decoratively printed on the housing case. Thus, a disposing position of the near field communication antenna is not restricted by a frame of the housing case and an inner surface shape of the housing case. Accordingly, a near field communication antenna having a larger size can be provided to the portable device.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram showing a switch side of a vehicular portable device according to the present disclosure;

FIG. 2 is a diagram showing a rear side of the vehicular portable device according to the present disclosure;

FIG. 3 is a diagram showing a first surface of a substrate;

FIG. 4 is a diagram showing a second surface of the substrate;

FIG. 5 is a diagram showing a cross-sectional view of the vehicular portable device shown in FIG. 1 in line V-V;

FIG. 6 is a diagram showing an enlarged view of the vehicular portable device shown by a dashed line in FIG. 5; and

FIG. 7 is a diagram showing a pattern shape of an NFC antenna.

### EMBODIMENTS FOR CARRYING OUT INVENTION

### First Embodiment

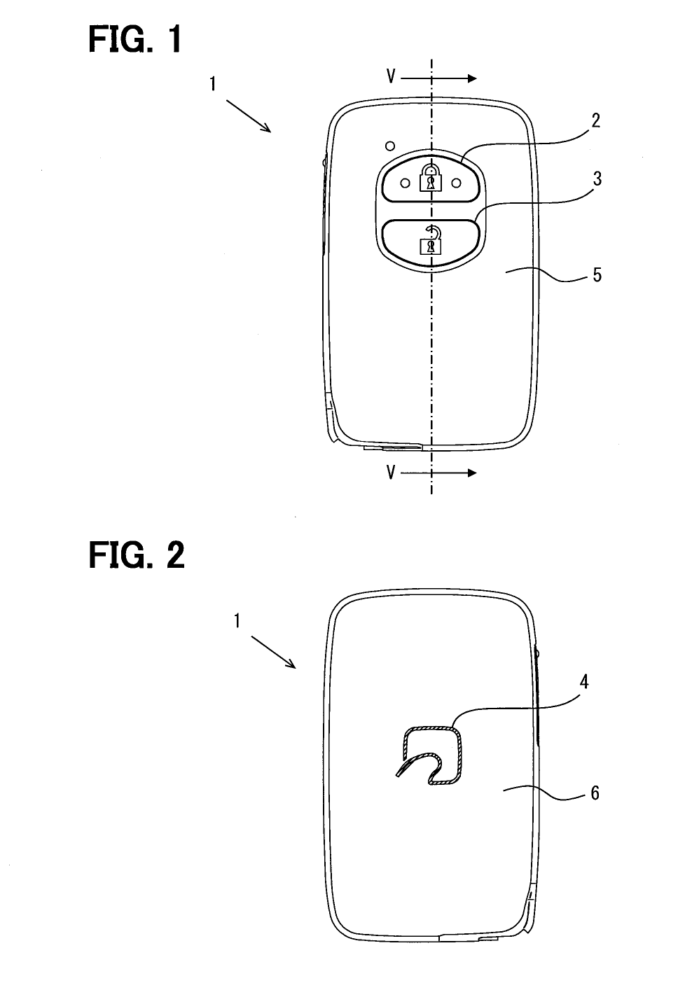

The following will describe embodiments of the present disclosure with reference to the drawings. A portable device 1 for vehicle (hereinafter, referred to as a portable device) shown in FIG. 1 and FIG. 2 has an approximately rectangular shape in plan view. As shown in FIG. 1, a locking switch 2 and an unlocking switch 3 are disposed on a switch side of the portable device 1. A user operates the locking switch 2 to instruct a locking of a vehicle door, and the user operates the unlocking switch 3 to instruct an unlocking of the vehicle door. As shown in FIG. 2, a mark 4 that is a decorative printing on a back side of the portable device 1 is viewable from outside of the back side. The mark 4 shown in FIG. 2 is a registered trademark of FeliCa Networks Inc. Hereinafter, the switch side of the portable device 1 is also referred to as a front side.

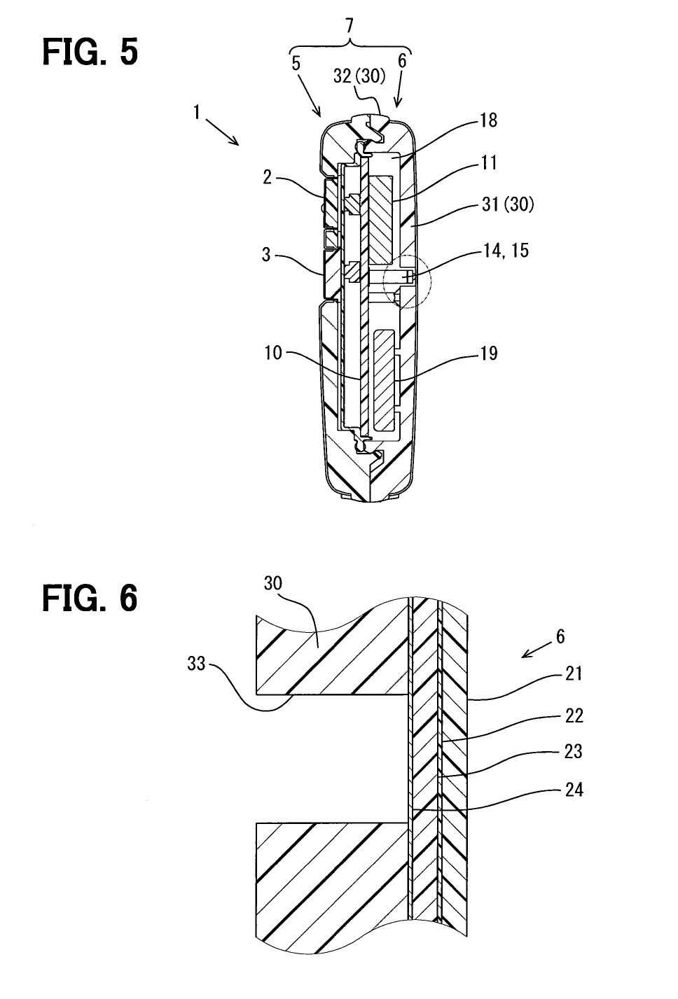

As shown in FIG. 1, FIG. 2, and FIG. 5, the portable device 1 includes a housing case 7 having an approximately rectangular parallelepiped shape. The housing case 7 has a front sub case 5 corresponding to the front side and a back sub case 6 corresponding to the back side. FIG. 1 also shows a plan view of the front sub case 5 of the portable device 1. FIG. 2 also shows a plan view of the back sub case 6 of the portable device 1. The front sub case 5 and the back sub case 6 configure the housing case 7.

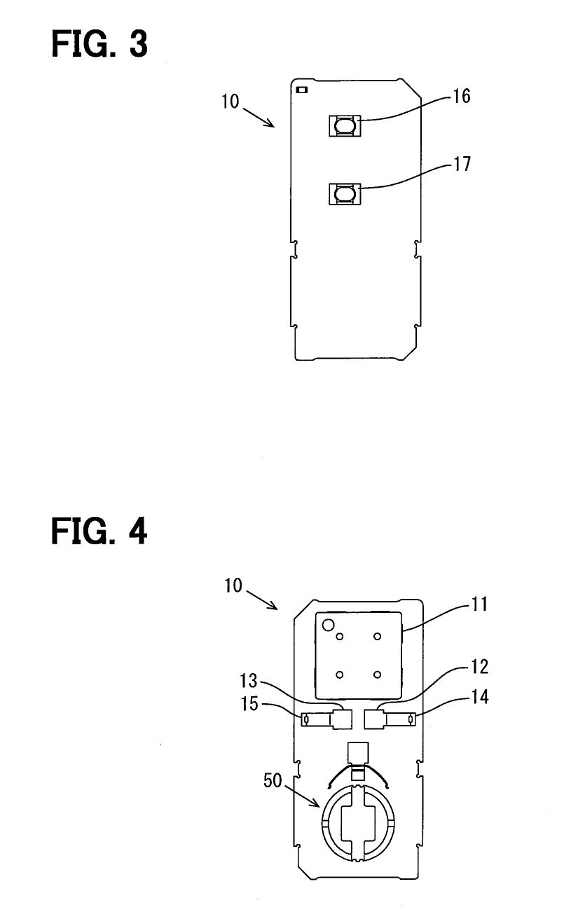

The housing case 7 houses a substrate 10 shown in FIG. 3 and FIG. 4 at an inside portion of the housing case 7. The substrate 1 has a first surface opposed to the front sub case and a second surface opposed to the back sub case. As shown in FIG. 4, a three-axis antenna 11 is disposed on the second surface of the substrate 10. The three-axis antenna 11 is a short range communication antenna utilized in the short range wireless communication. When the locking switch 2 or the unlocking switch 3 is pressed, the three-axis antenna 11 transmits a radio wave to a wireless device equipped to the vehicle.

A battery mounting portion 50 is disposed on the second surface of the substrate 10. As shown in FIG. 5, a battery 19 is mounted on the battery mounting portion 50. Further, a pair of substrate side terminals 12, 13 is disposed on the second surface of the substrate 10. The pair of substrate side terminals 12, 13 is connected with an NFC antenna 40, which will be described later. A pair of contact springs 14, 15 is integrally formed with the pair of the substrate side terminals 12, 13. The contact springs 14, 15 are provided by plate springs. The contact springs 14, 15 may also be provided by coil springs.

As shown in FIG. 3, a first switch contact 16 and a second switch contact 17 are disposed on the first surface of the substrate 10. The first switch contact 16 corresponds to the locking switch 2, and the second switch contact 17 corresponds to the unlocking switch 3. The first switch contact 16 becomes conductive when the locking switch 2 is pressed, and the second switch contact 17 becomes conductive when the unlocking switch 3 is pressed. Although not shown in the drawings, an electric circuit for short range wireless communication, an electric circuit for NFC communication, and various electronic components are disposed on the first surface of the substrate 10.

As shown in the cross-sectional view of FIG. 5, each of the front sub case 5 and the back sub case 6 has a box shape, which has a small depth and has an opening that opens to one direction. A housing space 18 is defined in the portable device 1 by an assembly of the front sub case 5 with the back sub case 6. The front sub case 5 is assembled with the back sub case 6 such that the opening of the front sub case 5 is opposed to the opening of the back sub case 6. The substrate 10, the three-axis antenna 11, and the battery 19 are disposed in the housing space.

Each of the front sub case 5 and the back sub case 6 includes a base resin portion, a film layer, and a printing layer disposed between the base resin portion and the film layer. Each of the front sub case 5 and the back sub case 6 having this kind of structure is formed by a film insert molding method.

In the film insert molding method, the film layer, the decorative layer, and the base resin portion are integrally molded as one body. Since the film insert molding is a well-known art, details of the film insert molding is not described herewith. The film layer may be provided by transparent resin material, such as polycarbonate or the like.

As shown in FIG. 6, the back sub case 6 further includes an antenna printing layer 24. Specifically, as shown in FIG. 6, the back sub case 6 includes an external film layer 21, a decorative printing layer 22, an internal film layer 23, and the antenna printing layer 24 laminated in the describing order from an outside of the back sub case 6 to an inside of the back sub case 6. Further, the back sub case 6 includes a base resin portion 30 disposed on a side of the antenna printing layer so that the base resin portion 30 is opposed to the substrate 10. That is, the base resin portion 30 is formed on a surface of the antenna printing layer 24 so that the base resin portion 30 is opposed to the second surface of the substrate 10.

As shown in FIG. 5, the base resin portion 30 may have a similar shape with the back sub case 6. The base resin portion has a box shape. The base resin portion 30 includes a bottom portion 31 and a frame portion 32. The external film layer 21 and other layers are formed as the bottom portion 31, and the frame portion 32 is formed at an external periphery of the bottom portion 31.

The NFC antenna 40 is provided by the antenna printing layer 24. The antenna printing layer 24 providing the NFC antenna 40 may be formed by a screen printing. Further, the decorative printing layer 22 may also be formed by a screen printing, and a design is printed on the decorative printing layer 22.

Similar to a normal case in which each of the film layer and the printing layer is a single layer structure, the layers and the resin portion are laminated and the film insert molding is performed to the laminated layers and resin portion to generate the sub case as one body. The external film layer 21 and the internal film layer 23 are provided by normally used material of film layer. Usually, the film layer is made of transparent resin material. Further, the film layer may be made of colored resin material. The film layer 21, 23 may have a thickness within a range of 0.2 millimeter (mm) to 0.3 mm.

The printing layer 22, 24 may have a thickness of, for example, around 10 micrometers (μm).

The external film layer 21, the decorative printing layer 22, the internal film layer 23, and the antenna printing layer 24 are formed on almost entire outer surface of the base resin portion 30. That is, the antenna printing layer 24 is formed on almost entire outer surface of the base resin portion 30.

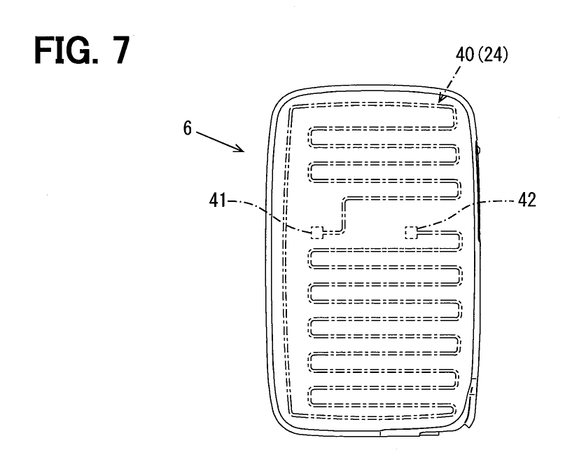

FIG. 7 shows the antenna printing layer 24. As shown in FIG. 7, the

NFC antenna 40 can be disposed on the entire surface of the back sub case 6. The NFC antenna 40 includes two antenna terminals 41, 42. The two antenna terminals 41, 42 are opposed to respective substrate side terminals 12, 13 disposed on the substrate 10. As shown in FIG. 5 and FIG. 6, the base resin portion 30 defines through holes 33 disposed in a direction of penetrating the base resin portion 30. The through holes 33 are disposed corresponding to the antenna terminals 41, 42 so that the antenna terminals 41, 42 are exposed to the housing space 18. Since none of the external film layer 21, the decorative printing layer 22, the internal film layer 23, or the antenna printing layer 24 has the through hole 33, the housing space 18 can be protected from water penetration.

As shown in FIG. 5, the contact springs 14, 15, which are integrally formed with the respective side terminals 12, 13, are in contact with respective antenna terminals 41, 42 through the through holes 33. With this configuration, the antenna terminals 41, 42 of the NFC antenna 40 are electrically connected with the respective substrate side terminals 12, 13.

In the present embodiment, the NFC antenna 40 is printed on the back sub case 6 by decorative printing. Thus, a disposing position of the NFC antenna 40 is not restricted by a shape of the frame portion 32 of the base resin portion 30 of the back sub case 6 and an inner surface shape of the back sub case 6. Thus, as shown in FIG. 7, the NFC antenna 40 may be disposed on almost entire surface of the back sub case 6. That is, an available disposing range of the NFC antenna 40 is increased. For example, the NFC antenna 40 having a size larger than a size of the substrate 10 or having a size larger than an internal boundary of the frame portion 32 of the base resin portion 30 can be provided to the portable device 1. Thus, the NFC antenna having a relatively large size can be provided to the portable device 1.

In the present embodiment, the antenna printing layer 24 is disposed closer to the surface of the housing case 7 compared with a case in which the antenna printing layer 24 is disposed on the substrate 10. Thus, a distance between the antenna printing layer 24 and an antenna equipped to a communication partner device can be decreased compared with the case in which the antenna printing layer 24 is disposed on the substrate 10. Thus, the portable device 1 is communicable with other device from a longer distance compared with the case in which the antenna printing layer 24 is disposed on the substrate 10.

In the present embodiment, the back sub case 6 has two film layers including the external film layer 21 and the internal film layer 23. The antenna printing layer 24 that provides the NFC antenna 40 is disposed on the inner side of the internal film layer 23. Thus, during an applying of a pressure to mold the back sub case 6, the outer surface of the back sub case 6 can be formed without protrusions or recesses caused by a pattern shape of the NFC antenna 40.

In the present embodiment, the antenna terminals 41, 42 of the NFC antenna 40 are electrically connected with respective substrate side terminals 12, 13 that are disposed on the substrate 10 via respective contact springs 14, 15. Thus, when replacing the battery, the front sub case 5 can be separated from the back sub case 6 without a distance restriction compared with a case in which the antenna terminals 41, 42 are electrically connected with respective substrate side terminals 12, 13 by wires that are electrically connected to each side by soldering. With this configuration, battery replacement can be performed with ease.

### Second Embodiment

In the foregoing embodiment, the portable device 1 has two film layers 21, 23. Alternatively, the portable device 1 may have only the external film layer without the internal film layer. By disposing only one film layer, a manufacturing cost of the portable device 1 can be reduced. When only the external film layer is provided, a thickness of the external film layer may be set equal to the thickness of the external film layer according to the first embodiment. Alternatively, the thickness of the external film layer according to the present embodiment may be set thicker than the thickness of the external film layer according to the first embodiment. For example, the external film layer according to the present embodiment may have a thickness equal to a sum of the thicknesses of the two film layers according to the first embodiment.

While the disclosure has been described with reference to preferred embodiments thereof, it is to be understood that the disclosure is not limited to the preferred embodiments and constructions. The disclosure is intended to cover various modification and equivalent arrangements. In addition, while the various combinations and configurations, which are preferred, other combinations and configurations, including more, less or only a single element, are also within the spirit and scope of the disclosure.

What is claimed is:

1. A portable device for a vehicle comprising:
a short range communication antenna utilized in a short range wireless communication with a communication device equipped to a vehicle;
a near field communication antenna utilized in a near field wireless communication; and
a housing case;
wherein the short range communication antenna is disposed in the housing case,
wherein the near field communication antenna is disposed on the housing case by decorative printing,
wherein the housing case includes an external film layer, a decorative printing layer, an internal film layer, and an antenna printing layer laminated in order in a direction from an outside portion of the housing case to an inside portion of the housing case, and
wherein the near field communication antenna is provided by the antenna printing layer.

2. (canceled)

3. The portable device according to claim 1, further comprising
a substrate on which the short range communication antenna is disposed,
wherein the near field communication antenna includes an antenna terminal provided by the antenna printing layer,
wherein the substrate includes a substrate side terminal that is connected with the antenna terminal of the near field communication antenna,
wherein the housing case further includes a base resin portion disposed on a surface of the antenna printing layer opposed to the substrate,
wherein the base resin portion defines a through hole at a position corresponding to the antenna terminal of the near field communication antenna so that the through hole penetrates the base resin portion, and
wherein the antenna terminal of the near field communication antenna is connected with the substrate side terminal via a contact spring.

4. The portable device according to claim 1, wherein a communicable range of the short range wireless communication is longer than a communicable range of the near field wireless communication.
